(19) United States
(12) Patent Application Publication
(10) Pub. No.: US 2015/0160739 A1
(43) Pub. Date: Jun. 11, 2015

(54) ACCORDION-STYLE COMPUTER KEY ENTRY DEVICE WITH FLAT, DISPLAY-PROTECTING, AND TILTED CONFIGURATIONS

(71) Applicant: Lenovo (Singapore) Pte. Ltd., New Tech Park (SG)

(72) Inventors: Cuong Huy Truong, Cary, NC (US); Gerard Francis Muenkel, Raleigh, NC (US)

(73) Assignee: Lenovo (Singapore) Pte. Ltd., New Tech Park (SG)

(21) Appl. No.: 14/101,784

(22) Filed: Dec. 10, 2013

(51) Int. Cl. G06F 3/02; H01H 13/86

(52) U.S. Cl. CPC G06F 3/0208; H01H 13/86; G06F 3/0221

(57) ABSTRACT

A system includes a foldable computer key entry device for inputting information to a computer. The device includes three panels, a main one of which bears key elements. The key entry device can have a flat horizontal configurations in which all three panels lie flat on a surface, a vertical stowed configuration in which all three panels lie flat against the display, and an intermediate accordion configuration in which the main panel is tilted up toward the display relative to the horizontal.

### FIELD

The present application relates generally to computer keyboards with multiple configurations.

### BACKGROUND

Computing systems such as notebook computers are often accompanied by key entry devices such as keyboards to usefully augment touch input capability of the computer display.

### SUMMARY

Present principles are directed to a key entry device for a computer that lies flat or can be raised at an angle off the horizontal (for ease of use) and that provides adjustability for use in limited space. It also provides a cover for the display in a stowed configuration, and may be mechanically coupled to the computer or may be a standalone device that is connected to the computer view a wired or wireless link but otherwise is physically separate from the computer.

Accordingly, a system includes an information handling system having a video display, a processor which controls the display to present demanded images on a display part thereof, and a key entry device by which a person can enter input to the processor. The key entry device includes a main panel, an intermediate panel, and a first hinge between the main and intermediate panels. The entry device also includes a support panel and a second hinge between the intermediate and support panels. As discussed in detail below, the key entry device has an accordion configuration, in which the main panel is angled relative to the intermediate panel at the first hinge and is not co-planar with the intermediate panel, and the support panel is angled relative to the intermediate panel at the second hinge and is not co-planar with the intermediate panel. In the accordion configuration the support panel lies flat on a surface that supports the display, and the intermediate panel is located between the main and support panels. The key entry device is movable to a flat horizontally extended configuration, in which all the panels lie flat in a common plane against the surface. And, the key entry device is movable to a vertical stowed configuration, in which all the panels lie flat in a common plane against the display to cover and protect the display.

In some examples, the main panel bears plural keys and the support panel bears no keys. The intermediate panel may also bear no keys. A hinge can be a living hinge or a mechanical hinge with plural discrete hinge elements. The main panel has a free end opposite the first hinge, and in the accordion configuration the free end rests on a surface on which the display rests. In contrast, in the accordion configuration the second hinge rests against a part of the display. The support panel may not be not hingedly connected to the display, or it may be hingedly connected to the display.

In another aspect, a device includes a foldable computer key entry device for inputting information to a computer. The key entry device includes at least three panels, a main panel of which bears key elements. The key entry device has a flat horizontal configuration in which all three panels lie flat on a surface, a vertical stowed configuration in which all three panels lie flat against a display, and an intermediate accordion configuration in which the main panel is tilted up toward the display relative to the horizontal.

In another aspect, a system includes a video display, a processor which controls the display to present demanded images on a display part thereof, and a key entry device by which a person can enter input to the processor. The key entry device includes a main panel, an intermediate panel, and a first hinge between the main and intermediate panels. The entry device also includes a support panel and a second hinge between the intermediate and support panels. The key entry device has an accordion configuration, in which the main panel is angled relative to the intermediate panel at the first hinge and is not co-planar with the intermediate panel, and the support panel is angled relative to the intermediate panel at the second hinge and is not co-planar with the intermediate panel. In the accordion configuration the support panel lies flat on a surface that supports the display, and the intermediate panel is located between the main and support panels. The key entry device is movable to a flat horizontally extended configuration, in which all the panels lie flat in a common plane against the surface. The key entry device is movable to a vertical stowed configuration, in which all the panels He flat in a common plane against the display to cover and protect the display.

The details of embodiments, both as to structure and operation, can best be understood in reference to the accompanying drawings, in which like reference numerals refer to like parts, and in which:

### BRIEF DESCRIPTION OF THE DRAWINGS

FIG. 1 is a block diagram of a system in accordance with present principles;

FIG. 2 is a perspective view of the keyboard in the accordion configuration to tilt the keyboard;

FIG. 3 is a perspective view of the keyboard in the flat horizontally extended configuration;

FIG. 4 is a perspective view of the keyboard in the vertical stowed configuration to cover the face of the display;

FIG. 5 is a schematic diagram of an example hinge, with portions of the panels broken away; and

FIGS. 6-9 are schematic side diagrams illustrating various configurations the foldable keyboard may take on.

### DETAILED DESCRIPTION

This disclosure relates generally to consumer electronics (CE) device based and/or workstation based based user information. With respect to any computer systems discussed herein, a system may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

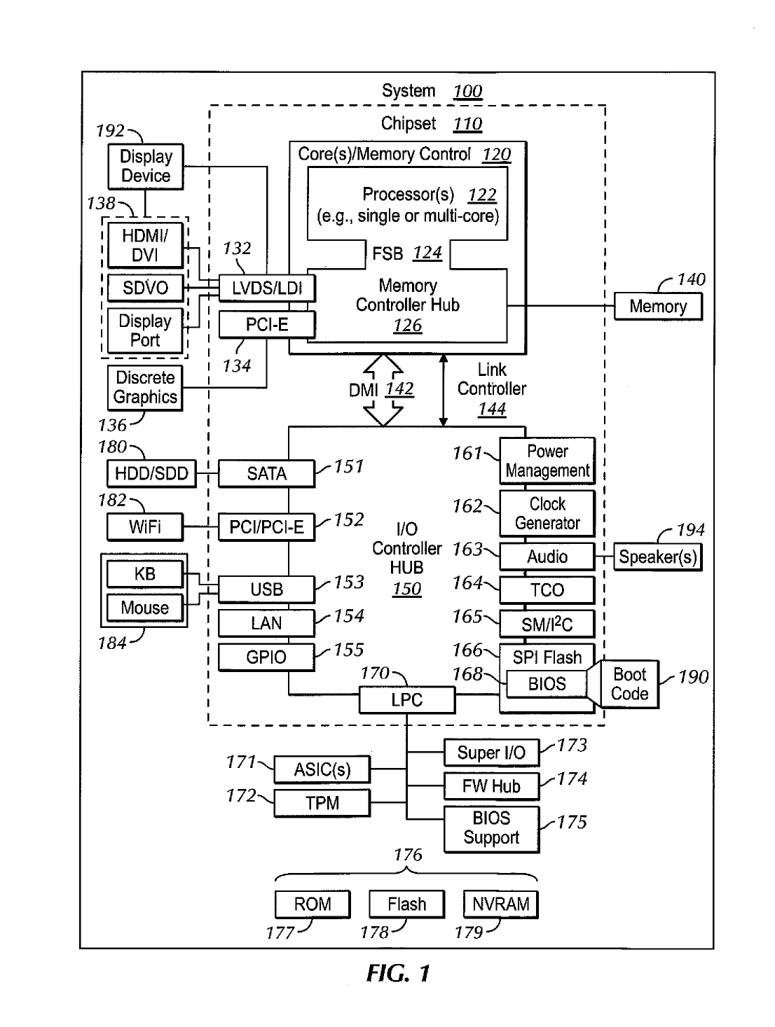

Now in reference to FIG. 1, a block diagram of an illustrative exemplary computer system 100 is shown. The system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory”.

The memory controller hub 126 further includes a low-voltage differential signaling interface (LVDS) 132. The LVDS 132 may be a so-called LVDS Display Interface (LDI) for support of a video display apparatus 192 (including, e.g., a CRT, a flat panel, a projector, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card. An exemplary system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface), a general purpose I/O interface (GPIO) 155, a low-pin count (LPC) interface 170, a power management interface 161, a clock generator interface 162, an audio interface 163 (e.g., for speakers 194), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes a basic input output system (BIOS) 168 and boot code 190. As used herein “BIOS” can mean BIOS in the traditional sense and also the newer standard for BIOS/unified extensible firmware interface (UEFI).

With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. Again, as described herein, an exemplary client device or other machine may include fewer or more features than shown in the system 100 of FIG. 1.

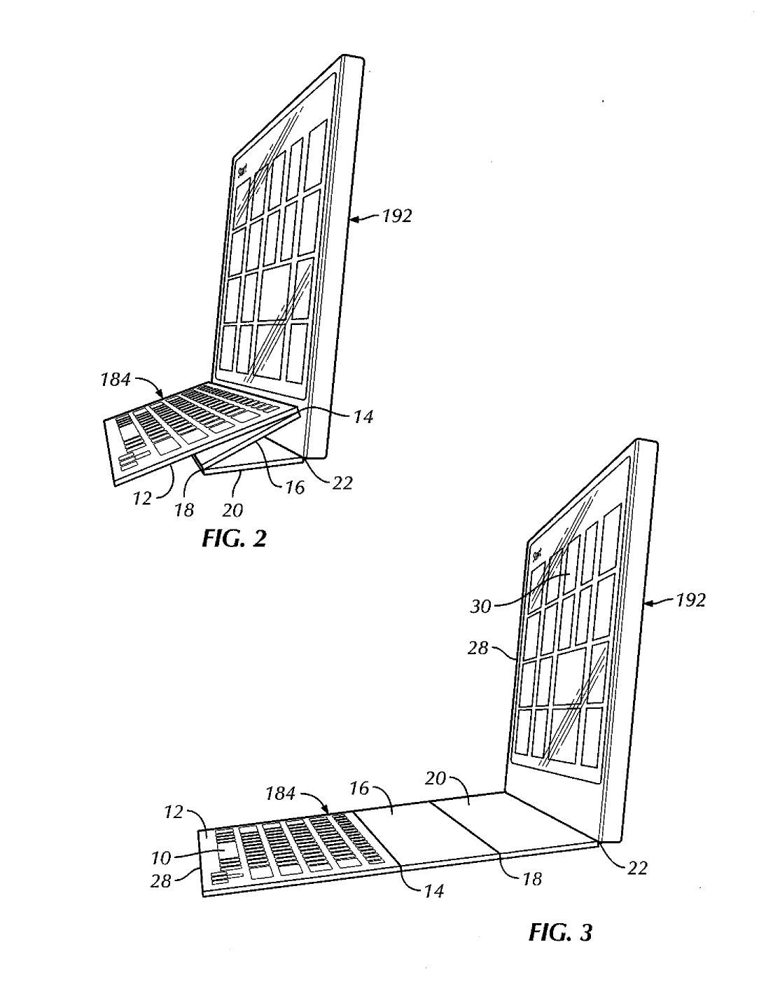

FIGS. 2-4 show an embodiment of the system 100 shown in FIG. 1 is in which the display 192, which may be housed with one or more of the various components shown in Figure 1, receives input from the input device 184, here configured as a foldable key entry device with plural keys 10 (FIG. 3) which may be, without limitation, membrane keys, soft keys, physical keyboard keys that can be depressed, etc. The keys 10 are on a main parallelepiped-shaped panel 12, which is connected via a first hinge joint 14 to a parallelepiped-shaped intermediate panel 16, which may or may not support keys, which in turn is connected via a second hinge joint 18 to a support panel 20, which typically does not include keys. The support panel 20 may be separate from the display 192 or it may be connected to the display 192 by a third hinge joint 22.

Thus, each panel 12, 16, 20 has a rectangular surface area, although other shapes may be used. In the embodiment shown, only the main panel 12 bears keys 10; the intermediate and support panels bear no keys. The panels 12, 16, 20 may be made of lightweight metal or plastic. The hinges 14, 18, 22 may be, when plastic is used, living hinges. Or, as shown briefly referring to FIG. 5, the hinges may be established by mechanical hinges with plural discrete elements such as respective thin rods 24 that extend from and parallel to an end of one panel (main panel 12 shown in FIG. 5 for ease of description) and that engage plural small partial (as shown) or complete rings 26 on the facing end of the adjacent panel, in rotatable engagement therewith. Other hinge structure may be used if desired.

The hinges 14, 18, 22 may as shown extend across substantially the entire edge of the panel(s) with which they are coupled. The width of the panels of the key entry device 184 may be the same as each other and the same as the width of the display 192, or the width of the key entry device 184 may be different from the width of the display 192.

FIG. 2 shows that the key entry device can have an accordion configuration, in which the main panel is angled relative to the intermediate panel at the first hinge and is not co-planar with the intermediate panel, and the support panel is angled relative to the intermediate panel at the second hinge and is not co-planar with the intermediate panel to establish a Z-like shape.

The accordion configuration may be established by rotating the main panel about the first hinge in a first rotational direction (e.g., counterclockwise) to establish a non-zero, non-180 degree angle, such as the acute angle shown, between the main and intermediate panels 12, 16. In this configuration, the free end 28 of the main panel 12 (the edge parallel to and opposite the first hinge 14) rests on the same surface on which the display 192 rests, with the main panel tilting up from the free end toward the display for ergonomic key input. It may readily be appreciated that the support panel 20 may be rotated about the second hinge in a second rotational direction (e.g., clockwise) that is opposite to the first rotational direction to establish a non-zero, non-180 degree angle, such as the acute angle shown, between the main panel and the support panel. In this configuration, the second hinge 18 may rest against, e.g., a bezel 28 that borders the outer edges of the video screen 30 of the display 192 with the support panel 20 lying flat on the same surface as the display 192 rests on. In the accordion configuration, as in the flat and stowed configurations shown in FIGS. 3 (and 7) and 4 (and 6), the intermediate panel 16 is always between the main and support panels 12, 20.

The key entry device 184 may be held in the accordion configuration shown by frictional resistance of the hinges, which may be overcome by gentle hand pressure, or by other suitable means.

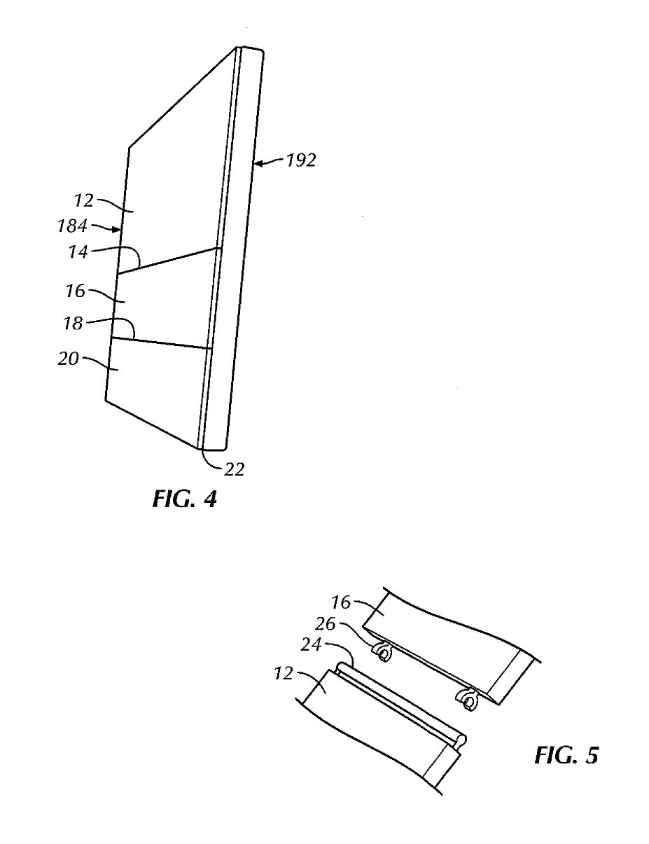

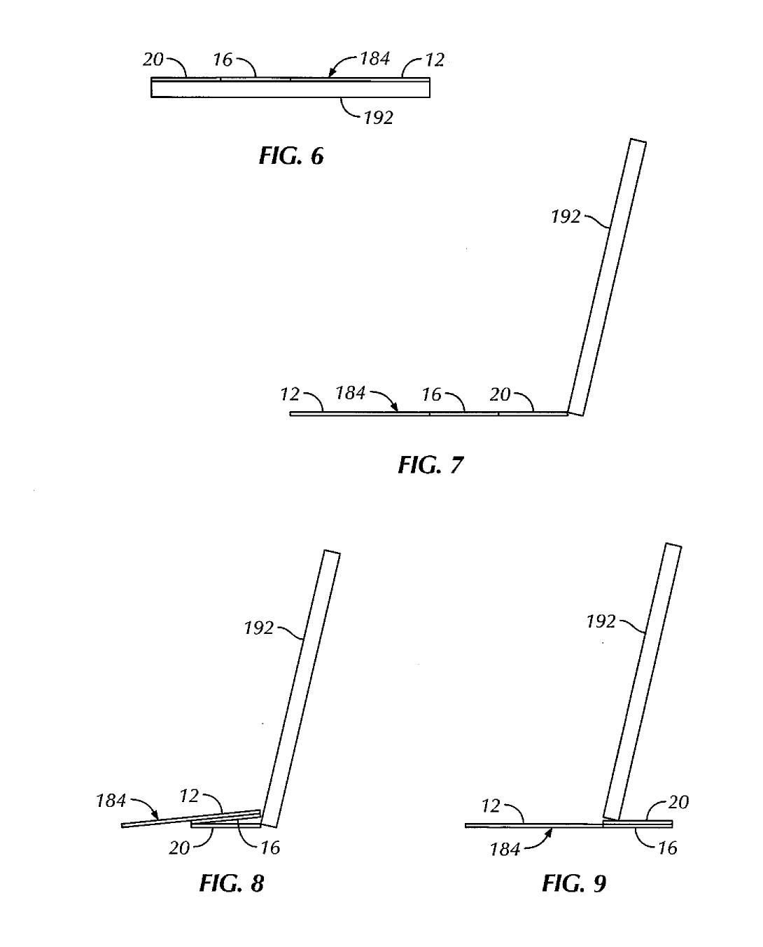

FIGS. 3 and 7 show the key entry device 184 in a flat horizontally extended configuration, in which all the panels 12, 16, 20 lie flat in the same plane against the surface. FIGS. 4 and 6 shows the key entry device in a vertical stowed configuration, in which all the panels 12, 16, 20 lie flat in the same plane against the screen of the display 192 to cover and protect the screen of the display 192.

FIG. 8 shows a flattened accordion configuration in which the panel 12 in the accordion configuration of FIG. 2 has been pushed down against the other panels 16, 20. FIG. 9 shows still another alternate configuration in which the intermediate and support panels 16, 20 have been folded flat against each other to lie on one side of the display 192 with the main panel 12 extending away from the opposite side of the display as shown, to conserve space on the main panel side of the display.

While the particular ACCORDION-STYLE COMPUTER KEY ENTRY DEVICE WITH FLAT, DISPLAY-PROTECTING, AND TILTED CONFIGURATIONS is herein shown and described in detail, it is to be understood that the subject matter which is encompassed by the present disclosure is limited only by the claims.

1. A system, comprising:
an information handling device having a video display;
a processor to control the display to present demanded images on a display part thereof; and
a key entry device by which a person can enter input to the processor, the key entry device comprising:
a main panel;
an intermediate panel;
a first hinge between the main and intermediate panels;
a support panel; and
a second hinge between the intermediate and support panels, the main panel, support panel, and intermediated panel not being the display, the main panel being joined to The intermediate panel without the display intervening therebetween, the intermediate panel Being joined to the support panel without the display intervening therebetween;
wherein the key entry device has an accordion configuration, in which the main panel is angled relative to the intermediate panel at the first hinge and is not co-planar with the intermediate panel, and in which the support panel is angled relative to the intermediate panel at the second hinge and is not co-planer with the intermediate panel, the intermediate panel being located between the main and support panels in the accordion configuration, wherein the key entry device is movable to a flat horizontally extended configuration, in which all the panels lie flat in a common plane against the surface, and wherein the key entry device Is movable to a vertical stowed configuration, in which all the panels lie flat in a common plane against the display to cover and protect the display.

2. The system of claim 1, wherein the main panel bears plural keys and the support panel bears no keys.

3. The system of claim 2, wherein the intermediate panel hears no keys.

4. The system of claim 1, wherein at least one hinge is a living hinge.

5. The system of claim 1, wherein at least one hinge is a mechanical hinge with plural discrete hinge elements.

6. The system of claim 1, wherein the main panel has a free end opposite the first hinge, and in the accordion configuration the free end rests on a surface on which the display rests.

7. The system of claim 1, wherein in the accordion configuration the second hinge rests against a part of the display.

8. The system of claim 1, wherein the support panel is not hingedly connected to the display.

9. The system of claim 1, wherein the support panel is hingedly connected to the display.

10. Device comprising:
a foldable computer key entry device for inputting information to a computer, the key entry device including at least three panels, a main panel of which bears key elements, the key entry device having a flat horizontal configuration in which all three panels lie flat on a surface, a vertical stowed configuration in which all three panels He flat against a first side of a display, and an intermediate accordion configuration in which the main panel is tilted up toward the display relative to the horizontal.

11. The device of claim 10, wherein the key entry device includes:
an intermediate panel establishing a second one of the three panels;
a first hinge between the main and intermediate panels;
a support panel establishing a third one of the three panels;
a second hinge between the intermediate and support panels;
wherein in the accordion configuration, the main panel is angled relative to the intermediate panel at the first hinge and is not co-planar with the intermediate panel, and the support panel is angled relative to the intermediate panel at the second hinge and is not co-planar with the intermediate panel, the intermediate panel being located between the main and support panels in the accordion configuration.

12. The device of claim 11, wherein the main panel bears plural keys and the support panel bears no keys.

13. The device of claim 12, wherein the intermediate panel bears no keys.

14. The device of claim 11 wherein at least one hinge is a living hinge.

15. The device of claim 11, wherein at least one hinge is a mechanical hinge with plural discrete hinge elements.

16. The device of claim 10, wherein the main panel has a tree end opposite the first hinge, and in the accordion configuration the free end rests on a surface on which the display rests.

17. The device of claim 11, wherein in the accordion configuration the second hinge rests against a part of the display.

18. The device of claim 10, wherein the key entry device is not hingedly connected to the display.

19. The device of claim 10, wherein the key entry device is hingedly connected to the display.

20. (canceled)
